(19) United States
(12) Patent Application Publication
(10) Pub. No.: US 2015/0231725 A1
(43) Pub. Date: Aug. 20, 2015

(54) DUAL DRIVE HYBRID WELDING

(71) Applicant: LINCOLN GLOBAL, INC., CITY OF INDUSTRY, CA (US)

(72) Inventor: Adam Hruska, Chardon, OH (US)

(73) Assignee: LINCOLN GLOBAL, INC., CITY OF INDUSTRY, CA (US)

(21) Appl. No.: 14/246,621

(22) Filed: Apr. 7, 2014

Related U.S. Application Data
(60) Provisional application No. 61/940,774, filed on Feb. 17, 2014.

(51) Int. Cl. B23K 9/10

(52) U.S. Cl. CPC B23K 9/1006

(57) ABSTRACT

The invention described herein generally pertains to a hybrid welding system, comprising a rotor-stator assembly including a rotor and a stator that provides electrical energy to a welding output bus, a combustion engine operatively coupled with the rotor to turn the rotor of the rotor-stator assembly, and an electric motor operatively coupled with the rotor to turn the rotor of the rotor-stator assembly. Various techniques for controlling operation of the electric motor and/or combustion engine can be employed.

### CROSS-REFERENCE TO RELATED APPLICATIONS AND INCORPORATION BY REFERENCE

This U.S. patent application is a continuation of and claims the benefit of U.S. provisional patent application 61/940,774 filed on Feb. 17, 2014, which is incorporated herein by reference in its entirety.

### TECHNICAL FIELD

Devices, systems, and methods consistent with the invention relate generally to welding equipment, and more particularly, to hybrid welding equipment, and still more particularly to supplementing power provided by a combustion engine with an electric motor.

### BACKGROUND OF THE INVENTION

Hybrid welders typically include a power supply that leverages both a combustion engine with other electrical power sources such as batteries to energize welders and associated operations. Solutions of this type are helpful to increasing available electrical power and ensuring its availability in varying conditions.

Hybrid welding power supplies can be configured to provide AC output to welders or other devices. However, when an electrical power source is connected directly to the output bus of the power supply providing power to the welder or other devices, the frequency of the AC output or other parameters may change in ways detrimentally impacting device performance. For example, changes to AC frequency can degrade weld performance or reduce the effectiveness of auxiliary devices.

Further, many hybrid welders are limited by horsepower caps in combustion engines. For example, environmental regulations require certain classes of devices to be limited at 25 horsepower. Higher-power devices can be much more expensive and maintenance intensive in part due to such environmental regulations.

### SUMMARY OF THE INVENTION

In accordance with the present invention, there is provided a rotor-stator assembly including a rotor and a stator that provides electrical energy to a welding output bus, a combustion engine operatively coupled with the rotor to turn the rotor of the rotor-stator assembly, and an electric motor operatively coupled with the rotor to turn the rotor of the rotor-stator assembly.

In another embodiment, there is provided a method for managing power provided to an output bus of a hybrid welding system, comprising turning a rotor of a rotor-stator assembly connected to an output bus of the hybrid welding system at least in part using a combustion engine, turning the rotor of the rotor-stator assembly connected to the output bus of the hybrid welding system at least in part using an electric motor, and providing power to a welder using the output bus of the hybrid welding system.

Additionally, a system is disclosed for providing power to a hybrid welding system, comprising an electrical power generation means for powering a hybrid welding system, combustion means for operating the electrical power generation means to generate electrical power, and an electro-mechanical means for operating the electrical power generation means to generate electrical power.

These and other objects of this invention will be evident when viewed in light of the drawings, detailed description, and appended claims.

### BRIEF DESCRIPTION OF THE DRAWINGS

The above and/or other aspects of the invention will be more apparent by describing in detail exemplary embodiments of the invention with reference to the accompanying drawings, in which:

FIGS. 1A, 1B, 1C, and Ware diagrams illustrating a hybrid welding device;

FIG. 2 illustrates a diagram of a dual-drive hybrid welding device;

FIG. 3 illustrates a diagram of a dual-drive hybrid welding device that receives feedback from a welding apparatus; and

FIG. 4 illustrates a methodology for utilizing an electric motor in conjunction with a combustion engine to provide power to a welder.

FIG. 5 illustrates a methodology for supplementing power from a combustion engine with an electric motor.

FIG. 6 illustrates a methodology for adjusting the electrical output in a hybrid welding system having both a combustion engine and an electric motor based on various welding operations or templates related to welding parameters and/or associated equipment.

### DETAILED DESCRIPTION

Embodiments of the invention will now be described below by reference to the attached figures. The described embodiments are intended to assist the understanding of the invention, and are not intended to limit the scope of the invention in any way. Like reference numerals refer to like elements throughout.

“Operative coupling” (or similar terms/phrases) used herein describes components which act upon one another. Such action can be accomplished through mechanical interaction of solid components which are directly connected or which exert forces on one another through various linkages or at a distance. Such action can also be accomplished through electrical, fluid, or other non-mechanical communication or energy transfer, which can be effected directly or via intervening and/or connecting components.

Aspects discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the discussed inventions. The embodiments and discussions herein can be incorporated into any such systems and methodologies by those of skill in the art on review of the disclosures. Devices or components associated with welding operations, including batteries used in such operations, are referred to herein as “welding components.”

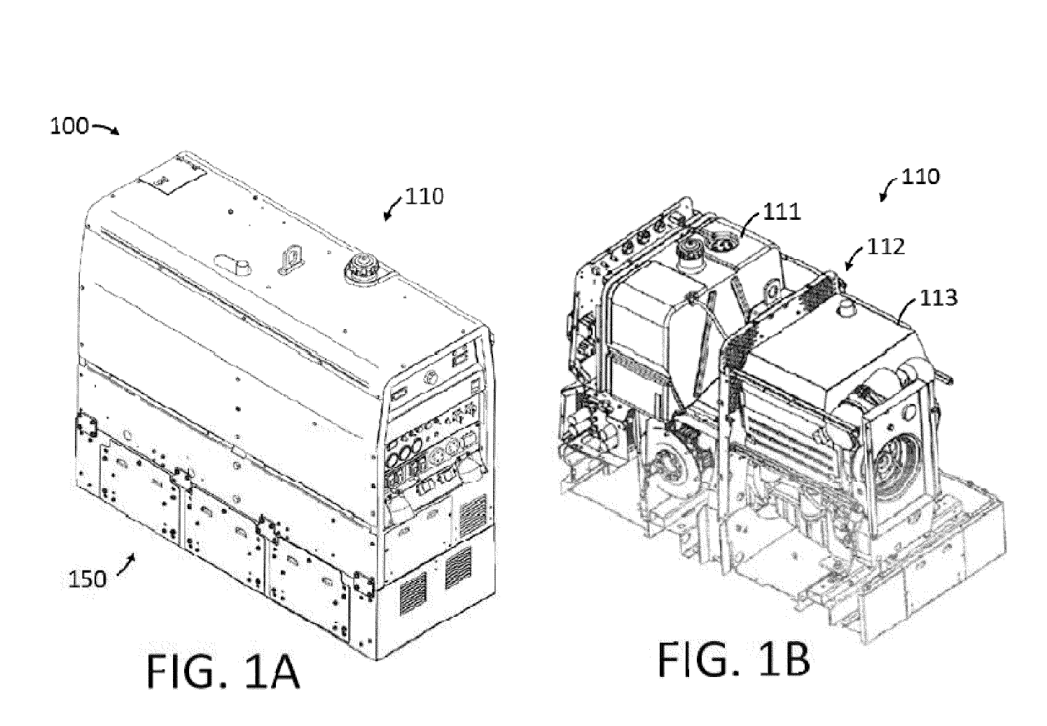

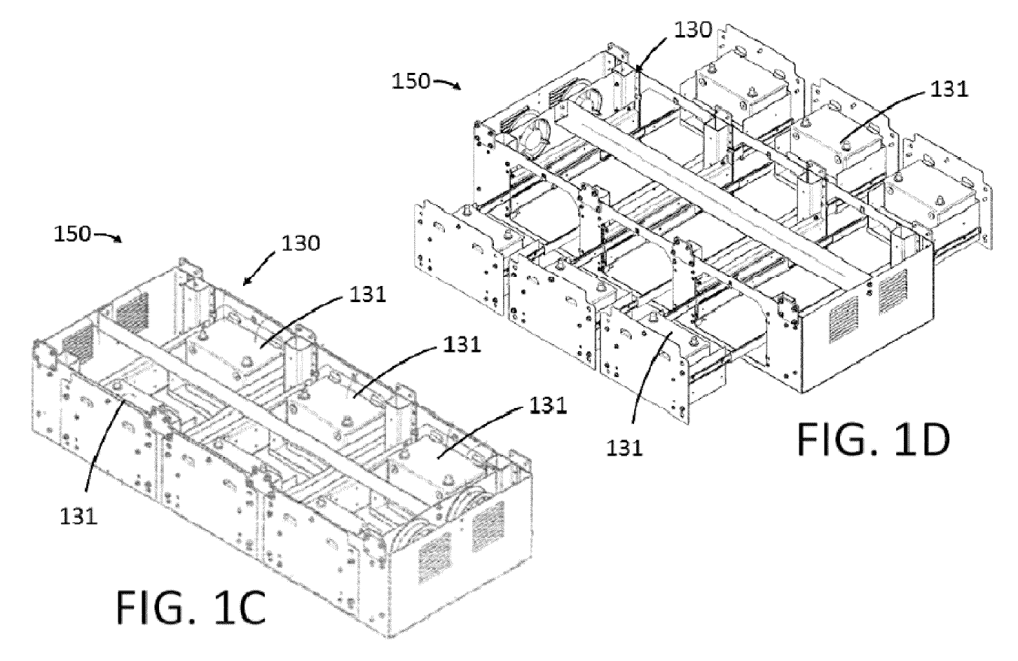

FIGS. 1A-1D illustrate a hybrid welding device (herein referred to as a “hybrid welder”). A hybrid welder according to the invention is generally indicated by the number 100 in the drawings. Hybrid welder 100 includes an engine component that runs on fuel from fuel storage 111 allowing the hybrid welder 100 to be portable. It will be appreciated that hybrid welder 100 may also be mounted in a permanent location depending on the application. Hybrid welder 100 generally includes a motor-driven welder assembly 112 having a motor 113 and an energy storage device 150. Motor 113 may be an internal combustion engine operating on fuels typically used in engine-driven (or hybrid) welding systems including but not limited to gasoline, diesel, ethanol, natural gas, hydrogen, and the like. These examples are not limiting as other motors or fuels may be used.

The motor 113 and energy storage device 150 may be operated individually or in tandem to provide electricity for the welding operation and any auxiliary operations performed by hybrid welder 100. For example, individual operation may include operating the motor 113 and supplementing the power from the motor 113 with power from the energy storage device 150 on an as-needed basis, or supplying power from the energy storage device 150 alone when the motor 113 is offline. Tandem operation may also include combining power from motor 113 and energy storage device 150 to obtain a desired power output. According to one aspect of the invention, a welder 100 may be provided with a motor having less power output than ordinarily utilized, and energy storage device 150 used to supplement the power output to raise it to the desired power output level. For example, a motor with no more than 19 kW (25 hp) output may be selected and supplemented with six 12 volt batteries to provide power for welding or other operations. Other combinations of motor output may be used and supplemented with more or less power from an energy storage device. The above example, therefore, is not limiting.

Energy storage device 150 may be any alternative power source including a secondary generator, kinetic energy recovery system, or, as shown, one or more batteries 131. Batteries 131 can be maintained in a battery bank 130 that electrically integrates batteries 131. Batteries 131 can be accessed in battery bank 130 using various movable members. In an embodiment, six batteries 131 are wired in series to provide power in connection with motor-driven welder assembly 112. In one embodiment, batteries 131 are lead acid batteries. Other types of batteries may be used in alternative or complementary embodiments, including but not limited to NiCd, molten salt, NiZn, NiMH, Li-ion, gel, dry cell, absorbed glass mat, and the like. Further, different sizes, ratings, or specifications of batteries can be employed without departing from the scope or spirit of such technologies.

Modes for carrying out the invention will now be described for the purposes of illustrating embodiments known to the applicant at the time of the filing of this patent application. The examples and figures are illustrative only and not meant to limit the invention, which is measured by the scope and spirit of the claims.

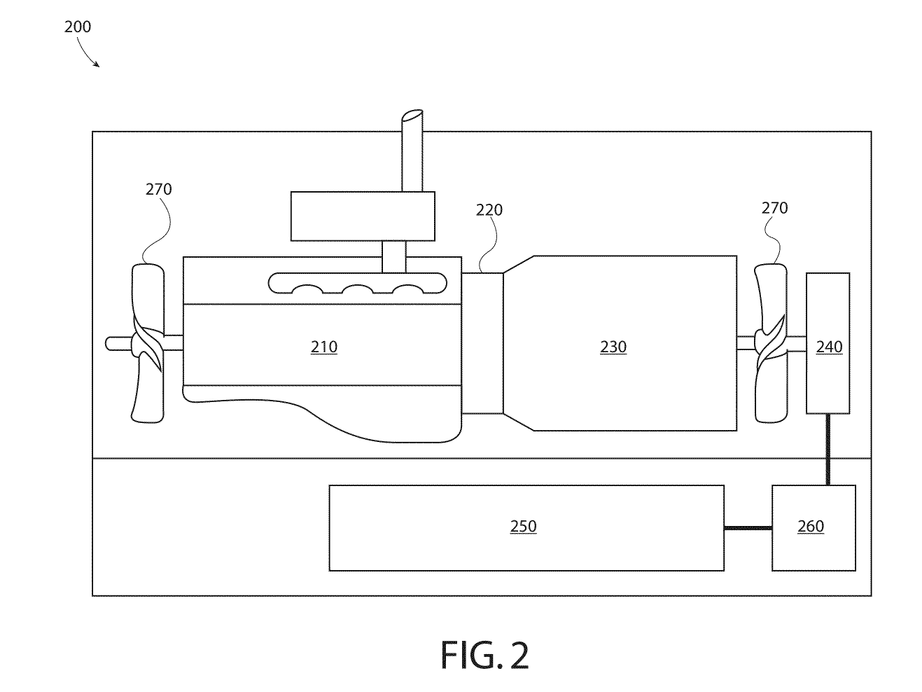

FIG. 2 illustrates a dual-drive hybrid welding device 200. Dual-drive hybrid welding device 200 includes combustion engine 210, clutch 220, rotor-stator assembly 230, electric motor 240, and battery bank 250, which work in conjunction to provide power to a welder (e.g., welding torch apparatus) and/or one or more additional electrically powered devices (not pictured).

Combustion engine 210 can be a combustion engine suitable for generating power for a hybrid welder, fueled by diesel, petroleum, propane, methanol/ethanol, or other appropriate fuels. Combustion engine 210 is operatively coupled with clutch 220, which can selectively permit the transmission of power to rotor-stator assembly 230. While clutch 220 is shown in FIG. 2, it is understood that alternative embodiments of the subject innovation may couple combustion engine 210 and rotor-stator assembly 230 without use of a clutch.

In at least one embodiment, a rotor of rotor-stator assembly 230 can be turned, wholly or in part, using combustion engine 210. Rotor-stator assembly 230 includes a power output for providing power to a welder or other components based on the energy generated.

Depicted inline with rotor-stator assembly 230 is electric motor 240. Electric motor 240 can be connected directly to rotor-stator assembly 230, or through a second clutch (not pictured) depending on the configuration. Further, while electric motor 240 is depicted inline, those of ordinary skill in the art will appreciate other possible configurations on review of this disclosure.

Electric motor 240 is operatively coupled with rotor-stator assembly 230 such that electric motor 240 boosts the power to rotor-stator assembly 230 by supplementing the energy provided by combustion engine 210. In one or more embodiments, the electronic motor is operatively coupled with a single driveshaft or axle coincident or operatively coupled with at least a portion of the rotor of rotor-stator assembly 230, and which is acted upon by combustion engine 210. Electric motor 240 can be powered by battery bank 250, or another available source of electrical power.

In single-drive hybrid welder apparatuses, battery bank 250 is connected directly to the output bus providing electrical power to a welder or other device. However, in dual-drive hybrid welding device 200, battery bank 250 is operatively coupled with electric motor 240 and can provide power to energize electric motor 240, which in turn increases power through rotor-stator assembly 230.

Motor controller 260 is shown connected to battery bank 250 and electric motor 240, and can provide at least a control signal for the operation of electric motor 240. For example, motor controller 260 can control battery power from battery bank 250 provided to electric motor 240 to start, stop, or change the cyclic rate of electric motor 240. While motor controller 260 is depicted between electric motor 240 and battery bank 250, it is understood that control circuitry (e.g., a switch) can be disposed between electric motor 240 and battery bank 250, and can be controlled using motor controller 260 arranged elsewhere in dual-drive hybrid welding device 200.

Motor controller 260 can be connected to or receive input from manual or automatic controls. Manual controls can include various controls permitting an operator to enable one or more modes of operation in electric motor 240 using motor controller 260. Automatic controls can effect control of electric motor 240 via motor controller 260 through knowledge of states related to dual-drive hybrid welding device 200, various feedback, and functions of such states or feedback. In one or more embodiments, various aspects of motor controller 260 can be implemented as hardware, software, or a combination thereof.

Additional components can be included to improve operation or efficiency of dual-drive hybrid welding device 200. For example, fans 270 can be coupled along an axle/driveshaft to facilitate air circulation throughout dual-drive hybrid welding device 200. In this fashion, temperature can be controlled. In specific embodiments, fans 270 can be selectively engaged or disengaged depending on system parameters.

Battery bank 250 can include one or more batteries suitable to hybrid welding systems. In embodiments, battery bank 250 includes batteries designed to discharge and recharge for the operational life of dual-drive hybrid welding device 200. In alternative embodiments, battery bank 250 can be arranged to permit exchange of batteries as their performance degrades through repeated use or damage. Various combinations of rechargeable and single-use batteries can be employed in a single battery bank 250 without departing from the scope or spirit of the innovation.

In an embodiment of operation, dual-drive hybrid welding device 200 energizes connected components (e.g., welding torches and associated components utilizing electrical power) using power generated at rotor-stator assembly 230. In one embodiment, rotor-stator assembly 230 can be primarily powered by combustion engine 210. When additional power is needed (e.g., demand higher than output, combustion engine reducing cyclic rate, combustion engine in low fuel state), motor controller 260 energizes electric motor 240 using power from battery bank 250. Electric motor 240 then drives rotor-stator assembly 230 to supplement (or replace) rotational energy imparted to the rotor from combustion engine 210. This increases the power output of rotor-stator assembly 230 without requiring increased output from combustion engine 210, and permits stable AC frequency to be provided to downstream components.

By utilizing an electric motor 240 to supplement combustion engine 210, smaller combustion engines can be utilized (e.g., 25 horsepower or less) while providing electrical output equivalent to larger apparatuses (e.g., increasing output above that provided by combustion horsepower). This reduces engine byproducts, accords with environmental regulations, and reduces required maintenance (both to remedial environmental components and the engine itself) in terms of lubricants, filters, pumps, exhaust fluids, et cetera.

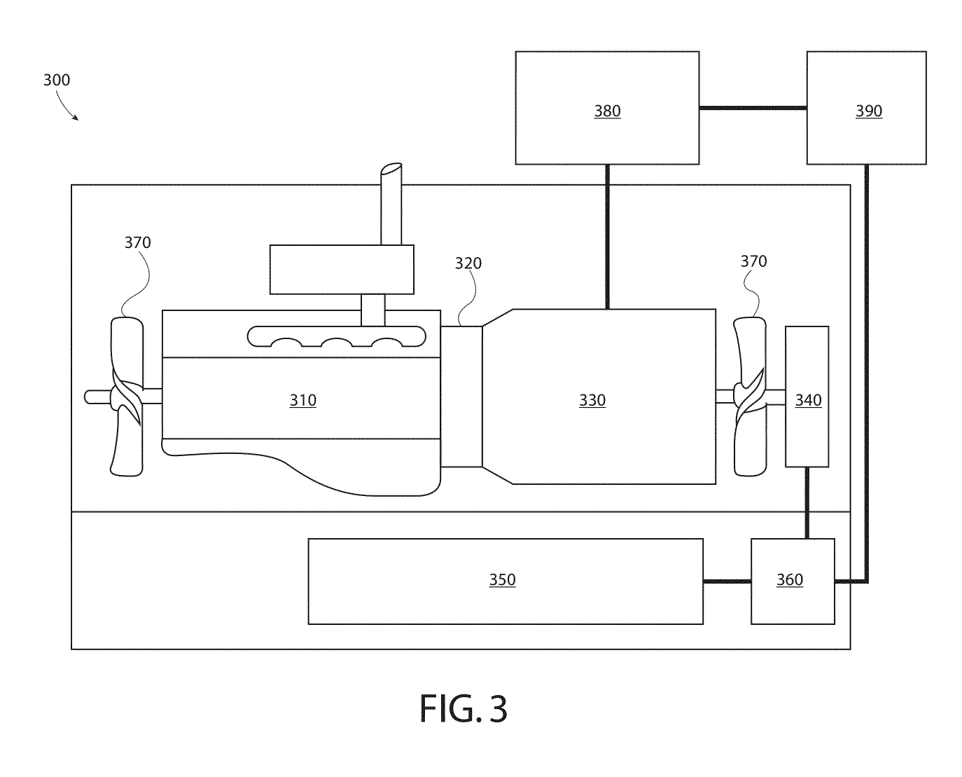

Additional details are discussed in relationship to the embodiment of a dual-drive hybrid welding device 300 depicted in FIG. 3. Dual-drive hybrid welding device 300 includes combustion engine 310, clutch 320, rotor-stator assembly 330, electric motor 340, and battery bank 350. Rotor-stator assembly 330 is operatively coupled with load 380, and provides power to one or more electrically-powered components (e.g., welding torches, welding accessories) of load 380.

Load 380 is operatively coupled to feedback component 390 which detects various states, parameters, or other values associated with load 380 and/or dual-drive hybrid welding device 300 in general. For example, required electrical power and associated parameters (voltage, current, AC frequency) can be detected and stored or transmitted to facilitate control of dual-drive hybrid welding device 300 or other purposes (e.g., operator displays, usage logs).

Feedback component 390 provides feedback to at least motor controller 360, which utilizes feedback to selectively control electric motor 340. For example, with respect to variables related to load 380, if a power demand exceeds that which can be provided by combustion engine 310, a signal indicating a power deficiency can be provided to motor controller 360. Motor controller 360 can interpret the power deficiency signal and in response energize electric motor 340 (at least in part using electricity from battery bank 350) to a cyclic rate which will provide power at least adequate to overcome the power deficiency. In another example, with respect to variables related to dual-drive hybrid welding device 300 at large, feedback component can also be operatively coupled (e.g., directly receiving signals wired or wirelessly, or connected through load 380) to one or more of combustion engine 310, clutch 320, rotor-stator assembly 330, electric motor 340, battery bank 350, et cetera, and receive feedback information related to one or more thereof. In this example, electric motor 340 can overheat, whereafter feedback component will transmit a signal to motor controller 360 to reduce the output of electric motor 340.

Motor controller 360 can include various logics (e.g., circuit, software) to receive, acknowledge, and/or interpret feedback received from feedback component 390 (or another source of data). In one or more embodiments, various functions or algorithms are associated with motor controller 360 to permit motor controller 360 to change operational parameters of at least electric motor 340 in accordance with optimization of dual-drive hybrid welding device 300 and associated components. In one embodiment, motor controller 360 energizes and de-energizes electric motor 340 according to power required by load 380. In another embodiment, motor controller 360 continually adjusts the cyclic rate of electric motor 340 according to an instantaneous demand for electrical power from load 380 over a continuous scale of output.

Motor controller 360, using feedback from feedback component 390, can apply various settings to dual-drive hybrid welding device 300. For example, a balancing algorithm can determine optimal mixes or ratios of power from combustion engine 310 and/or electric motor 340 in accordance with variables to be optimized. For example, optimizations relating to battery life, fuel efficiency, temperature control, system uptime, power availability, and other ends can be performed based on past or current feedback, and motor controller 360 can apply operational parameters to effect the calculated optimization.

Further, a user or optimization algorithm can define various modes of operation which are implemented or enforced by motor controller 360. Examples of modes of operation can include an “eco-mode” (minimize emissions), modes directed to preferred power sources or techniques (prefer electric, prefer combustion), modes associated with specific welding torches or other electrically powered components, modes specific to an operating environment (e.g., cold weather), and others. Various templates or schemas can be stored in a control database accessible to one or more of motor controller 360, feedback component 390, and/or other components operatively coupled with dual-drive hybrid welding device 300.

In an embodiment, dual-drive hybrid welding device 300 can include an engine controller (not pictured) and/or other control systems which work in conjunction with motor controller 360. In this fashion, engine 310 (or other components) can be managed according to operator input, or templates or schemas of a control database.

The elements of dual-drive hybrid welding device 300 can be located in configurations other than that illustrated. While battery bank 350 is shown as an integral component and disposed beneath compartment(s) housing combustion engine 310 and other components, it is understood that battery bank 350 can be located in any portion of dual-drive hybrid welding device 300 in various embodiments. Further, battery bank 350 can be located remote from dual-drive hybrid welding device 300 in various embodiments, or can be shared among multiple devices including, but not limited to, dual-drive hybrid welding device 300.

Further, combustion engine 310 and/or electric motor 340 can be arranged in configurations other than those illustrated in FIG. 3. For example, through use of belt drive configurations, geared mechanical interfaces, or various linkages, one or both of combustion engine 310 and/or electric motor 340 can be disposed about an axle/driveshaft to act through other members. Thus, it is not necessary that either or both of combustion engine 310 and electric motor 340 be attached to the axle/driveshaft inline.

Electrical and electronic components can exchange electrical signals via remote wiring, and/or can exchange data using wireless communication techniques. In this regard, such components can be located remotely or realized through distributed architectures whereby multiple discrete electrical or electronic components act at a distance in concert to effect the component's function.

Further, while dual-drive hybrid welding device 300 is shown with one combustion engine 310 and one electric motor 340, multiple engines and/or motors can be utilized with the illustrated system or aspects thereof (e.g., load 380 can receive power from multiple devices, dual-drive hybrid welding device 300 includes two electric motors including electric motor 340) in various combinations without departing from the scope or spirit of the disclosure.

In addition to leveraging battery power from battery bank 350 to power electric motor 340, dual-drive hybrid welding device 300 can also recharge batteries of battery bank 350 in at least one embodiment. In one embodiment, an AC motor can be incorporated as a secondary generator to facilitate charging to avoid drawing power from rotor-stator assembly 330. Alternatively, an inverter can be incorporated to provide power for charging batteries of battery bank 350. In still further embodiments, electric motor 340 can remain clutched when not energized, and a charger can be integrated or coupled with electric motor 340, motor controller 360, or be provided as a standalone component in order to provide power for charging battery bank 350. Various techniques for charging or recharging batteries of battery bank 350, or providing electrical power for other purposes through conversion of mechanical energy provided by one or both of combustion engine 310 and electric motor 340, will be appreciated after study of the disclosures provided herein.

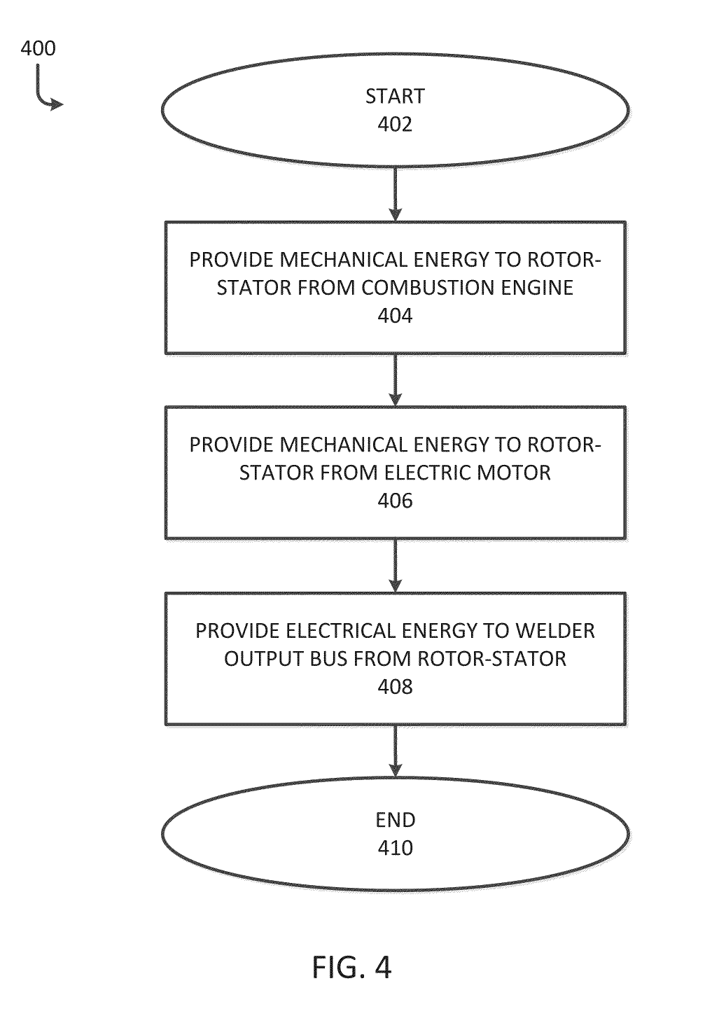

Turning now to FIG. 4, this drawing illustrates a methodology 400 for utilizing an electric motor in conjunction with a combustion engine to provide power to a welder. Methodology 400 starts at 402 and proceeds to 404 where mechanical energy is provided to a rotor-stator from a combustion engine. The combustion engine can be an internal combustion engine operating on fuels typically used in engine-driven or hybrid welders, including but not limited to gasoline, diesel, ethanol, natural gas, hydrogen, and the like. The combustion engine turns a shaft which is mechanically connected (directly or through other linkages) to the rotor of a rotor-stator assembly, which provides electrical energy to the welder.

At 404, mechanical energy is provided to a rotor-stator from an electric motor. Mechanical energy from an electric motor can be provided at 404 simultaneously with energy from combustion engine at 402, at a different time, or in various periodic arrangements. The electric motor turns the shaft on which the combustion engine also acts, thereby increasing or replacing the mechanical energy imparted on the rotor. In various embodiments, the electric motor may act on the shaft operatively coupled with the rotor through various linkages or other intervening components.

In one embodiment, the electric motor exerts rotational force on the shaft on occurrence of a condition (e.g., combustion engine output insufficient). For example, the combustion engine may be limited to a certain size or output (e.g., 25 horsepower) according to various regulations governing engine size. However, in some circumstances, such as during a high-demand welding operation in conjunction with associated devices, the combustion engine available may be insufficient to drive the rotor with enough force to generate the electrical energy necessary. In such instances, the electric motor can supplement the combustion engine's output to have the effect of a higher output engine acting on the rotor.

In alternative or complementary embodiments, the electric motor may act in other circumstances, such as in an “eco-mode” minimizing combustion emissions, a “portable life” mode which maximizes rotor activity given a finite supply of combustible fuel and battery life, and others. Various electrical or electronic devices (e.g., circuits, processors, memory, engine and/or motor controls, electrically-controlled clutches or transmissions, electrically-controlled throttles, and others) can be utilized to determine control solutions or combinations to apply to the combustion engine, electric motor, or other components, as well as effect the control itself.

At 408, electrical energy is provided to a welder output bus to which a welder is connected. The electrical energy is produced at least in part by the rotor-stator, the rotor to which it is coupled, directly or through various intervening components, to both a combustion engine and an electric motor. After power is provided to the welder output bus, methodology 400 ends at 410.

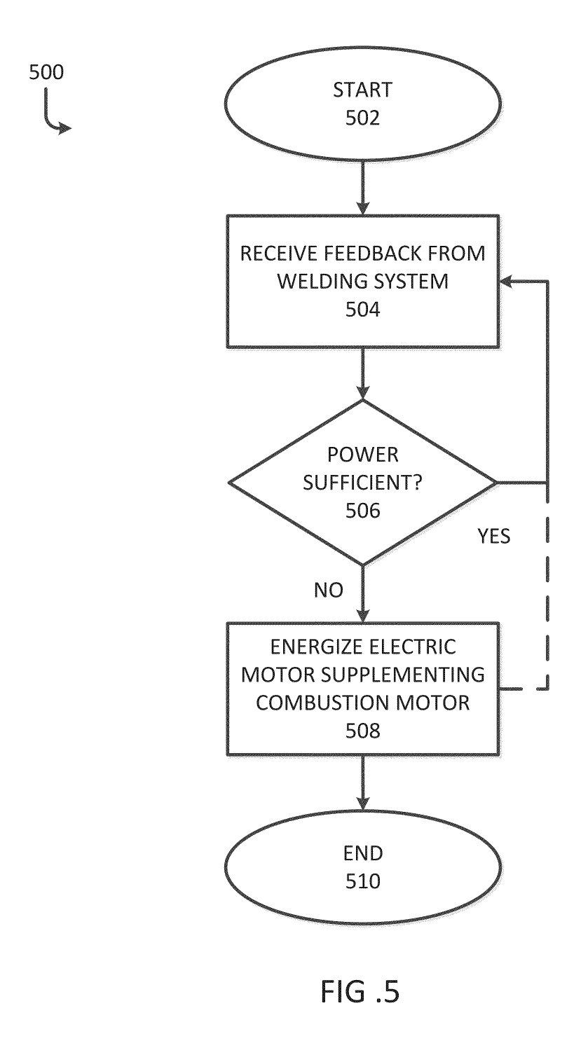

FIG. 5 illustrates methodology 500 for supplementing power from a combustion engine with an electric motor. Methodology 500 begins at 502 and proceeds to 504 where feedback is received from a welding system. The feedback can relate to a power consumption level (e.g., absolute or relative) or percentage (e.g., in reference to available power from output bus and/or other sources). The feedback can also be related to a rate of change of power consumption or expected power requirement (e.g., based on energizing of various welding components or associated equipment). In still further alternative or complementary embodiments, the feedback provides information on various welding parameters or operations, or related to the electrical signal (e.g., AC frequency). Additional feedback may be calculated based on changes to parameters or states, different detected parameters or states, attached equipment, and other variables related to the control of welders or associated equipment.

In further embodiments, a state may be set or reset at 502, including but not limited to determining a particular operating mode of a combustion engine acting on a rotor which, in combination with a stator, provides power to the welding system.

At 506, a determination is made as to whether power provided to the welding system is sufficient using the combustion engine. If the power is sufficient to perform the welding (and related) processes underway at the set parameters, methodology 500 returns to 504 where feedback is monitored.

However, if power is determined to be insufficient at 506, methodology 500 proceeds to 508 where an electric motor acting on the rotor is energized to supplement the force on the rotor and increase electrical power output. The electric motor can be energized alone, or in combination with changes to the operation of the combustion motor. Energizing the electric motor can be conducted as a binary instruction (e.g., on/off), or over a scale of output from the electric motor as controlled by a throttle. Once the electric motor is energized, power output is increased to overcome the deficiency. Thereafter, methodology 500 can end, having provided the output necessary to conduct the electrically-powered operations underway. Alternatively or optionally, methodology 500 can return to 504 to continue monitoring output to determine if additional system changes are necessary.

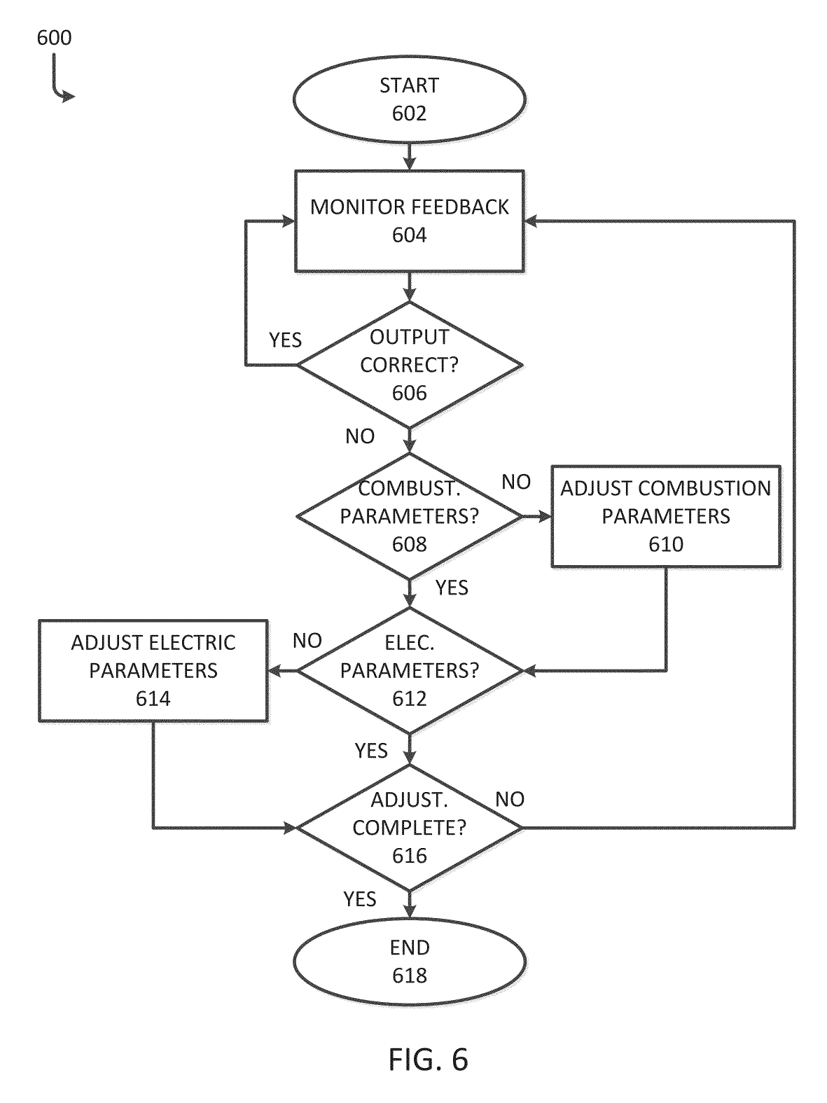

FIG. 6 illustrates methodology 600 for adjusting the electrical output in a hybrid welding system having both a combustion engine and an electric motor based on various welding operations or templates related to welding parameters and/or associated equipment. Methodology 600 begins at 602 and proceeds to 604 where feedback is monitored based on the state of welding operations underway or anticipated, or associated equipment.

At 606 a determination is made as to whether the hybrid welding system output is correct based on the feedback monitored. Whether the output is correct can depend on power deficiencies or surpluses based on current or expected load, parameters of the electrical power being provided (e.g., AC frequency), the means by which the electrical power is being provided (e.g., relative drive to rotor of combustion engine and/or electric motor), a power management scheme, available power sources (e.g., gasoline, battery), and other variables.

If the determination at 606 returns that the hybrid welding system output is correct, methodology returns to 604 where feedback can be monitored. However, if the determination at 606 resolves that the hybrid welding system output is not correct, methodology 600 proceeds to 608 where a determination is made as to whether operating parameters of the combustion engine are correct. If the determination at 608 returns negative, methodology 600 proceeds to 610 where combustion engine parameters are adjusted (e.g., change to throttle to combustion engine, energize or de-energize combustion engine).

If the determination at 608 returns positive, or after adjustments to the combustion engine parameters are complete at 610, methodology 600 proceeds to 612 where a determination is made as to whether operating parameters of the electric motor are correct. If the determination at 612 returns negative, methodology 600 proceeds to 614 where electric motor parameters are adjusted (e.g., change to throttle to combustion engine, energize or de-energize combustion engine). In an alternative embodiment, changes to parameters of the electric motor can be completed before adjusting parameters of the combustion motor, or both sets of parameters may be adjusted simultaneously.

After adjustments are made to the operating parameters of one or both of the combustion engine and/or electric motor, or after determining no adjustments are necessary, methodology 600 proceeds to 616 where a determination is made as to whether all adjustments are complete. This determination can be based on completion of the adjustments resolved earlier, or calculations using updated feedback received or determined in real-time during the adjustments. If the determination at 616 returns negative, methodology 600 recycles to 604 where additional feedback is monitored to complete and additional round of adjustments to operating parameters in one or both of the combustion engine and the electric motor. If 616 returns positive, and both the combustion engine and electric motor are running according to the required or prescribed output, methodology 600 proceeds to end at 618.

Required outputs as referenced above can refer (but are not limited) to requirements in electrical signals such as necessary voltage or current, or an AC frequency appropriate for powering specific devices or operations. Prescribed outputs as described above can generally relate (but are not limited) to particular templates of operation or optimization, such as “eco-mode” (e.g., minimize emissions or waste), maximum portable life mode (e.g., maximize length of operation without refueling and/or recharging), combustion engine bias mode (e.g., preference to use combustion engine unless electric motor required), electric motor bias mode (e.g., preference to use electric motor unless combustion engine required), balanced mode (e.g., maintaining a specific ratio of combustion engine power and electric motor power), and others, which can apply preferred settings to the combustion engine and/or electric motor. In at least one embodiment, a user can select a prescribed output (e.g., select “eco-mode”), or prioritize prescribed outputs generally or based on feedback in a predicted situation (e.g., prefer “eco-mode” and next opt for maximum portable life when attached device load does not exceed a wattage threshold, and so forth).

While methodologies 400, 500, and 600 show particular embodiments of methodologies herein, one of ordinary skill in the art will appreciate that various methodologies or steps thereof can repeat, be conducted in a different order, and so forth. Steps can occur concurrently, such as during continuous temperature monitoring or where control is based on other feedback.

Aspects herein are generally discussed in reference to an electric motor which acts on a rotor axle, either directly or through one or more mechanical elements operatively coupled therewith, which is also driven by a combustion engine. However, alternative embodiments in which two or more rotors are separately driven by one or more combustion engines and/or one or more electric motors are also understood in view of the disclosures herein.

Further, although aspects herein have generally described the function of combustion engines and electric motors as “on,” “off,” or generalized output as a setting between minimum and maximum, those of ordinary skill in the art will appreciate how geared embodiments can be integrated without departing from the scope of the disclosure. For example, various gears and transmissions can permit one or more combustion engines and/or electric motors to shift using a transmission thereby changing the work completed by a single cycle.

While embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention. Other variations, related and unrelated to those briefly described above, will be understood by those of skill in the art upon review of the disclosures herein.

What is claimed is:

1. A hybrid welding system, comprising:
a rotor-stator assembly including a rotor and a stator that provides electrical energy to a welding output bus;
a combustion engine operatively coupled with the rotor to turn the rotor of the rotor-stator assembly; and
an electric motor operatively coupled with the rotor to turn the rotor of the rotor-stator assembly.

2. The hybrid welding system of claim 1, further comprising a battery bank operatively coupled to at least the electric motor.

3. The hybrid welding system of claim 1, further comprising an axle with which the rotor turns.

4. The hybrid welding system of claim 3, wherein the combustion engine is oriented substantially inline with the rotor on the axle.

5. The hybrid welding system of claim 3, wherein the electric motor is oriented substantially inline with the rotor on the axle.

6. The hybrid welding system of claim 1, further comprising a motor controller that provides control signals to the electric motor.

7. The hybrid welding system of claim 6, further comprising a feedback component that provides feedback to the motor controller based on a parameter of the hybrid welding system.

8. The hybrid welding system of claim 7, wherein the motor controller calculates an adjustment to at least the electric motor based on the feedback.

9. The hybrid welding system of claim 7, further comprising a combustion engine controller that calculates an adjustment to the combustion engine based on the feedback.

10. The hybrid welding system of claim 1, further comprising at least one clutch disposed between the rotor and one of the combustion engine and the electric motor.

11. A method for managing power provided to an output bus of a hybrid welding system, comprising:
turning a rotor of a rotor-stator assembly connected to an output bus of the hybrid welding system at least in part using a combustion engine;
turning the rotor of the rotor-stator assembly connected to the output bus of the hybrid welding system at least in part using an electric motor; and
providing power to a welder using the output bus of the hybrid welding system.

12. The method of claim 11, further comprising determining feedback related to at least one parameter of the hybrid welding system.

13. The method of claim 12, further comprising adjusting operation of at least one of the combustion engine and the electric motor based on the feedback.

14. The method of claim 13, wherein adjusting operation of the at least one of the combustion engine and the electric motor includes increasing or decreasing a cyclic rate at which the at least one of the combustion engine and electric motor is operating.

15. The method of claim 13, wherein adjusting operation of the at least one of the combustion engine and the electric motor includes conforming the combustion engine and the electric motor to a prescribed output.

16. A system for providing power to a hybrid welding system, comprising:
an electrical power generation means for powering a hybrid welding system;
a combustion means that acts on a drive means to operate the electrical power generation means to generate electrical power; and
an electro-mechanical means that acts on the drive means to operate the electrical power generation means to generate electrical power.

17. The system of claim 16, further comprising means for processing feedback related to the hybrid welding system.

18. The system of claim 17, further comprising means for solving at least one optimization related to one or more of the combustion means and the electro-mechanical means based on the feedback.

19. The system of claim 18, further comprising means for controlling the one or more of the combustion means and the electro-mechanical means based on the at least one optimization.

20. The system of claim 18, further comprising an electrical storage means that energizes the electro-mechanical means.
